(19) United States
(12) Patent Application Publication
(10) Pub. No.: US 2002/0000771 A1
(43) Pub. Date: Jan. 3, 2002

(54) FLAT PANEL DISPLAY WITH IMPROVED MICRO-ELECTRON LENS STRUCTURE

(76) Inventors: SHICHAO GE, SAN JOSE, CA (US); CHARLES S LEUNG, SAN JOSE, CA (US); LAP MAN YAM, SARATOGA, CA (US)

Correspondence Address: Matthew E. Connors, Esq., Samuels, Gauthier & Stevens LLP, 225 Franklin Street, Suite 3300, Boston, MA, 02110, US

(21) Appl. No.: 09/138,293

(22) Filed: Aug. 21, 1998

(51) Int. Cl. H01J 1/62; H01J 63/04

(52) U.S. Cl. 313/495

(57) ABSTRACT

In a display device employing field emitter cathodes and an anode, a microelectron lens structure is interposed between the cathodes and anode. The spacings between the anode, lens structure and the cathodes and the aperture shape of the lens structure and the applied voltage to the anode, cathodes and the lens structure effectively control the focusing and imaging of the electrons onto corresponding pixel dots for displaying desired images.

### CROSS REFERENCE TO RELATED APPLICATION

This application is related to an application filed on the same day and by the same Applicants as this application, the related application entitled “DISPLAY DEVICE WITH IMPROVED GRID STRUCTURE,” which is referred to herein as the companion application. The companion application is incorporated herein by reference in its entirety.

### BACKGROUND OF THE INVENTION

This invention relates in general to flat panel displays and in particular, to a flat panel display device employing an improved micro-electron lens structure.

Many flat panel display devices have been proposed. In U.S. Pat. No. 5,083,058 toNonomura et al., for example, a flat panel display device is proposed where one or more layers of struts formed by a screen printing method are used as spacers between cathodes on or near a back plate and an anode on or near a front plate.

The display device proposed by Nonomura et al. is disadvantageous for several reasons. The display device employs a complicated and complex control grid structure which is difficult to manufacture, especially for high resolution displays. For example, it is tedious and impractical to screen print high aspect ratio struts with fine pitch. Nonomura et al.'s device employs intermediate electrode structures comprising multiple beam control grids with top and bottom electrodes on insulating plates with holes. It may be difficult to accurately align the multiple beam control layers with the struts on the front and back plates, especially for high resolution displays.

None of the flat panel displays currently on the market or proposed are entirely satisfactory. It is, therefore, desirable to propose a flat panel display device where the above-described difficulties are alleviated.

### SUMMARY OF THE INVENTION

This invention is based on the recognition that by simply employing a layer of an electrically conductive material with a two-dimensional array of holes therein and by applying an electrical potential to the layer, the layer forms a micro-electron lens for focusing and/or imaging that greatly improves the performance and increases manufacturing tolerance of the display. Preferably the front and back plates of the display are separated by spacers that permit the spacing between the anode and cathodes to be of a desired value. This permits the paths of electrons to be focused and/or imaged by the micro-electron lens structure.

Since the electrical potential applied to this micro-electron lens structure can be altered to achieve the desired focusing and/or imaging effects, the alignment between the cathode elements and pixel dots can be relaxed so that the flat panel display device made employing such structure has a higher tolerance for misalignment during manufacture. Furthermore, the holes in the structure can be made to be of considerable size to permit a high percentage of electrons generated by the cathode elements to pass.

The electrons generated by a set of cathode elements are focused by a corresponding micro-electron lens to form an image of the set at the luminescent layer. In this context, each set of cathode elements has an image at the luminescent layer. In one embodiment, the lateral dimensions of at least one of the holes are preferably at least one-tenth of the lateral extent of a corresponding set of cathode elements. More preferably the lateral dimensions of at least one of the holes are at least one-third of the lateral extent of a corresponding set of cathode elements.

One embodiment of the invention is directed towards a flat panel display device for displaying images when viewed in a viewing direction, comprising a front face plate and an anode on or near the front face plate. A first layer of luminescent material on or near the anode is employed. The layer comprises an array of rows and columns of sets of pixel dots of luminescent material. Each set of pixel dots contains at least one pixel dot. Each of the pixel dots emits red, green or blue light in response to electrons. An array of field emitter cathode elements on a cathode substrate is employed, where the array has rows and columns of sets of cathode elements. Each set of cathode elements contains at least one cathode element. A micro-electron lens structure is used including at least one layer of electrically conductive material between the anode and cathodes, where such layer defines a two-dimensional array of holes therein. Each set of pixel dots in the luminescent layer substantially overlaps an image of a corresponding set of cathode elements at the luminescent layer through a corresponding hole in the layer of the micro-electron lens structure. A controller applies an electrical potential to the anode, a scanning electrical potential sequentially to rows or columns of the cathode elements, data electrical potentials to columns or rows of the elements and a focusing and/or imaging electrical potential to the micro-electron lens structure. This causes electrons from each set of the cathode elements to reach its corresponding image of the corresponding set of pixel dots of the luminescent layer for displaying desired images. In the preferred embodiment, the micro-electron lens structure is an integral, unitary, one-piece structure, so that substantially the same electrical potential is applied at or near each of the holes therein.

Another embodiment of the invention covers a flat panel display device for displaying images when viewed in a viewing direction, comprising a front face plate, and an anode on or near the front face plate. A layer of luminescent material is disposed on or near the anode, where the layer includes an array of rows and columns of sets of pixel dots of luminescent material. Each set contains at least one pixel dot emitting red, green or blue light in response to electrons. An array of field emitter cathode elements on a cathode substrate is employed, where the array has rows and columns of sets of cathode elements, each set containing at least one cathode element. A micro-electron lens structure including a layer of electrically conductive material is employed between the anode and cathodes, where such layer defines a two-dimensional array of holes therein. Each set of pixel dots in the luminescent layer substantially overlaps a corresponding image of a set of the cathode elements through a corresponding hole in a layer of the micro-electrons structure. An array of grid electrodes is also employed between the anode and the cathode elements. A controller applies a focusing and/or imaging electrical potential to the layer of the micro-electron lens structure, an electrical potential to the anode, and addressing and data electrical potentials to the sets of cathode elements and the array of grid electrodes. This causes electrons emitted by each set of cathode elements to reach its corresponding image at the set of pixel dots of the luminescent layer for displaying desired images. In the preferred embodiment, the micro-electron lens structure is an integral, unitary, one-piece structure, so that substantially the same electrical potential is applied at or near each of the holes therein.

### BRIEF DESCRIPTION OF THE DRAWINGS

FIG. 1 is a cross-sectional view of a portion of a flat panel display device employing a micro-electron lens to illustrate a first embodiment of the invention where each hole of the lens corresponds to a corresponding pixel dot.

FIG. 2 is a cross-sectional view of a portion of a flat panel display device where a micro-electron lens structure is used for focusing and imaging to illustrate a second embodiment of the invention where each hole of the lens corresponds to a plurality of corresponding pixel dots.

FIG. 3A is a perspective view of a flat panel display device with a portion cut away to illustrate a third embodiment of the invention.

FIG. 3B is a portion of the display device of FIG. 3A in more detail.

FIG. 4 is a cross-sectional view of a flat panel display device employing a micro-electron lens structure with two or more layers of conductive material to illustrate a fourth embodiment of the invention.

FIG. 5 is a cross-sectional view of a portion of a flat panel display device similar to that of FIG. 1 except that it has a set of grid electrodes to illustrate a fifth embodiment of the invention.

For simplicity in description, identical components are identified by the same numerals in this application.

### DETAILED DESCRIPTION OF THE PREFERRED EMBODIMENTS

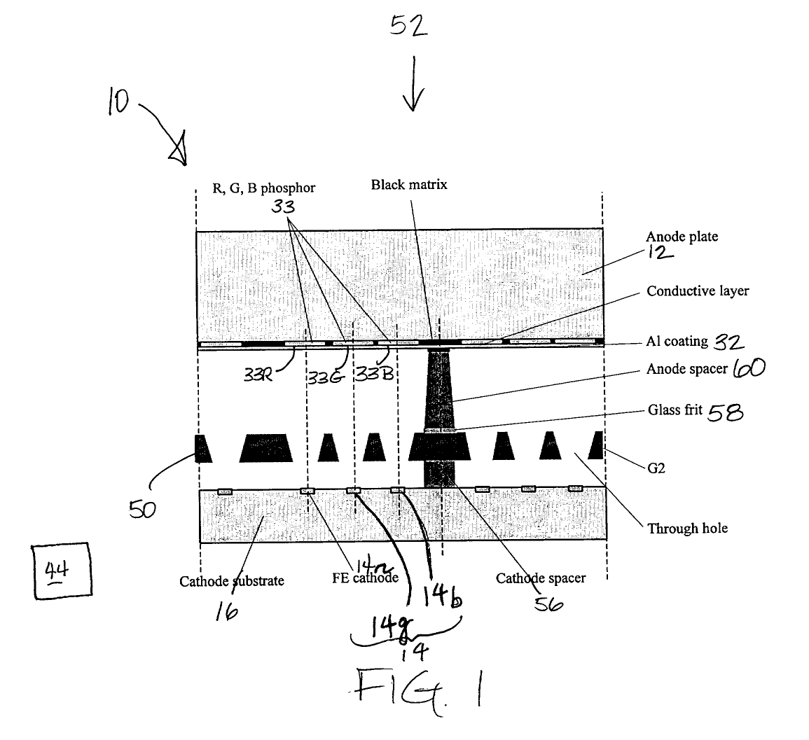

FIG. 1 illustrates a cross-sectional view of a portion of a flat panel display device 10 which includes an anode plate or front face plate 12 and a cathode substrate 16. On or in the top surface of the cathode substrate or plate and facing the front face plate is a two-dimensional array of sets of field emitter cathode elements 14. On the inside or bottom surface of the anode plate facing the cathode substrate is a phosphor layer 33 comprising pixel dots, where each pixel dot emits red, green or blue light when impinged upon by electrons. On the phosphor layer 33 is a conductive layer 32, such as an aluminum coating, which forms the anode 32. Layer 32 is typically thin enough so that electrons from the cathodes would penetrate the layer to reach the pixels dots for generating light. An electrically conductive layer 50 is held in place between the anode and the cathodes by cathode spacers 56 and anode spacers 60, where anode spacers 60 are attached to layer 50 and the anode by means of glass frit 58. Cathode spacers 56 may be formed by a process such as stencil printing onto layer 50 and attached to substrate 16.

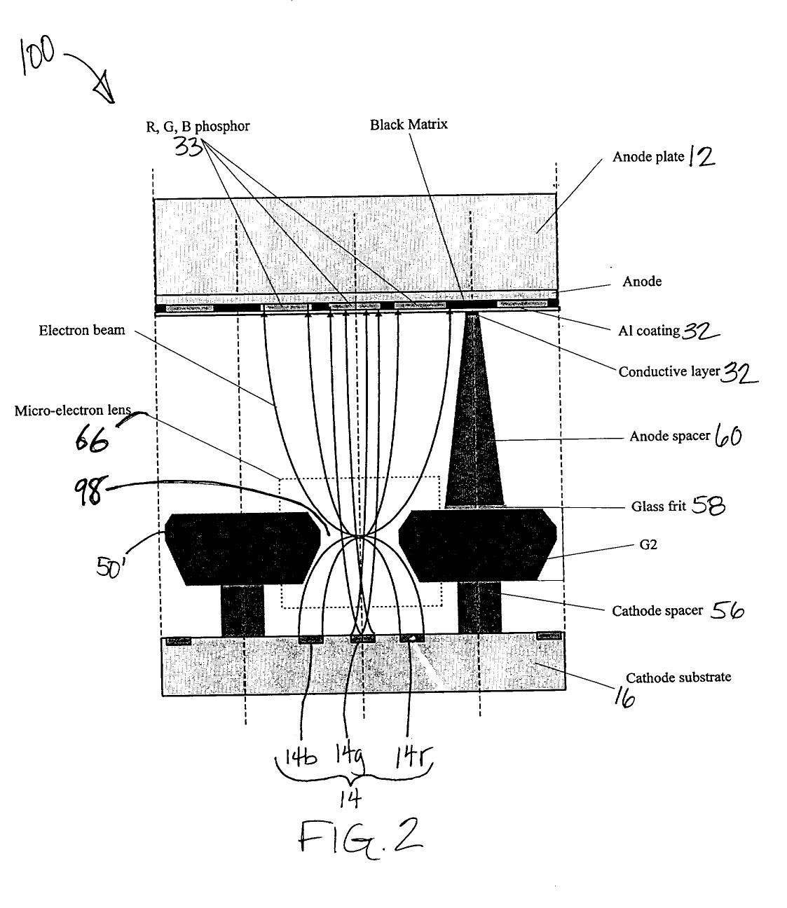

The thickness of the cathode spacers is such that the spacing between layer 50 and the cathode substrate is of the order of about 10 to 500 microns, and more preferably about 30 to 250 microns, and is of the order of about 100 microns in the embodiment of FIG. 1 and of the order of about 200 microns in the embodiment of FIG. 2. The anode spacers 60 preferably have heights such that layer 50 and anode 32 are spaced apart by not less than 0.5 millimeters, and more preferably by not less than about 1 millimeters, so that a relatively high potential difference of the order of 200 to 10,000 volts (more preferably 1,000 to 10,000 volts) may be applied between the anode 32 and cathodes 14. Since the cathodes 14 are typically operated at a low voltage, a relatively high voltage in a range of about 200 to 10,000 volts is then applied to the anode layer 32. This permits the phosphor layer 33 to be operated at or close to its optimum efficiency and lifetime.

For some applications, it may be possible to omit the anode spacers 60. If anode spacers are not used, it may be necessary to increase the thickness of the anode or front face plate 12 so that the housing of the display 10 comprising the anode plate 12 and any back plate are strong enough to withstand atmospheric pressure. If the potential difference between the cathode and the anode is not too high (e.g. not more than 300 volts), it may be possible to exchange the position between the aluminum coating 32 for the anode and the phosphor layer 33, so that the electrons from the cathodes 14 directly impinge upon the phosphor layer 33 without having to pass through the aluminum coating 32.

Pixel dots 33 are arranged in a two-dimensional array, where each pixel dot overlaps a corresponding set of field emitter cathode elements 14 and a corresponding hole in a two-dimensional array of holes in layer 50 when viewed in the viewing direction 52. As shown in FIG. 1, the pixel dot 33R overlaps the set 14r of cathode elements and a corresponding hole in layer 50, the pixel dot 33G overlaps the set 14g of cathode elements and a corresponding hole in layer 50, and the pixel dot 33B overlaps the set 14b of cathode elements and a corresponding hole in layer 50. The array of sets of field emitter cathode elements 14 form a two-dimensional array of rows and columns. Power supply in controller 44 applies (not shown) a scanning electrical potential sequentially to the rows of the sets of cathode elements and data electrical potentials to columns of the sets of elements to accomplish XY (two-dimensional) addressing and brightness control of the two-dimensional array of pixel dots 33 in order to display video images. Alternatively, the scanning electrical potentials may be applied sequentially to columns of sets of such cathode elements and data electrical potentials may be applied to the rows of such sets of elements for the same purpose. In addition, a focusing electrical potential may be applied to layer 50 to focus the electrons generated by each set of field emitter cathode elements to its corresponding and overlapping pixel dot in layer 33. Preferably the layer 50 is an integral, unitary one-piece structure, so that any electrical potential applied thereto will cause such potential to be applied at or near each hole in the layer.

As shown in FIG. 1, the pixel dots are grouped into clusters, each cluster containing a pixel dot emitting red light, a pixel dot emitting green light and a pixel dot emitting blue light in response to electrons, and the holes in layer 50 and the set of field emitter cathodes also form corresponding clusters. It will be understood, however, that the pixel dots may be grouped to form other types of clusters, such as where each cluster includes a pixel dot emitting red light, two pixel dots emitting green light and one pixel dot emitting blue light; all such variations in this and other embodiments of this invention are within the scope of the invention. Layer 50 forms a micro-electron lens that focuses the electrons emitted by each set of field emitter cathode elements to the corresponding pixel dot, to reduce the effect of any misalignments between the set of field emitter cathode elements, and its corresponding hole and pixel dot.

To further reduce cross-talk, cathode spacers 56 have thicknesses in the range of about 10 to 500 microns, and more preferably in the range of about 30 to 250 microns, and the lens layer 50 is at least about 10 microns from the cathode elements. Preferably, the thicknesses of the cathode spacers 56 are such that the spacing between layer 50 and the cathodes 14 is of the order of about 100 microns in the embodiment of FIG. 1. By maintaining each set of cathode elements at a close distance to its corresponding hole in layer 50, cross-talk is much reduced.

FIG. 2 is a cross-sectional view of a portion of a flat panel display device 100 substantially similar to display 10 of FIG. 1, except that the micro-electron lens 50′ is different from layer 50 of FIG. 1. In display 10 of FIG. 1, the electrons passing through each hole in layer 50 originate from essentially a single set of field emitter cathode elements and the electrons generated from each set of field emitter cathode elements are directed towards substantially a single pixel dot. In contrast, each hole of layer 50′ of FIG. 2 passes electrons originating from three or more sets of field emitter (FE) cathode elements where such electrons are directed towards three or more pixel dots. Electrons originating from the set 14r of field emitter cathode elements are focused and imaged by lens 50′ onto pixel dot 33R, those from set 14g focused and imaged onto pixel dot 33G and those from set 14b focused and imaged onto pixel dot 33B. When external voltage sources are provided to the anode, cathode elements and the micro-electron lens (conceptual structure 66 enclosed with dotted lines), equipotential lines (not shown) representative of electric fields originated from the anode, cathodes and micro-electron lens exist in the region of the micro-lens structure. Electrons are emitted from the FE cathodes 14 by applying an externally suitable voltage. These emitted electron beams are accelerated through the electric field in the region of the micro-electron lens and preferably collected at the anode.

The emitted electrons' transit trajectories (electron beams) originating from the FE cathodes 14 are controlled by the electric field in the spatial region of the micro-electron lens. The electric field in the region of the micro-electron lens is a function of the applied voltages to the anode, FE cathode elements and layer 50′ as well as the distance between the anode, FE cathode elements and layer 50′ and the aperture shape of the holes in layer 50 forming the micro-electron lens. In this respect, the emitted electron beams are focused and imaged onto the anode by structural characteristics and the parametric conditions of the micro-electron lens.

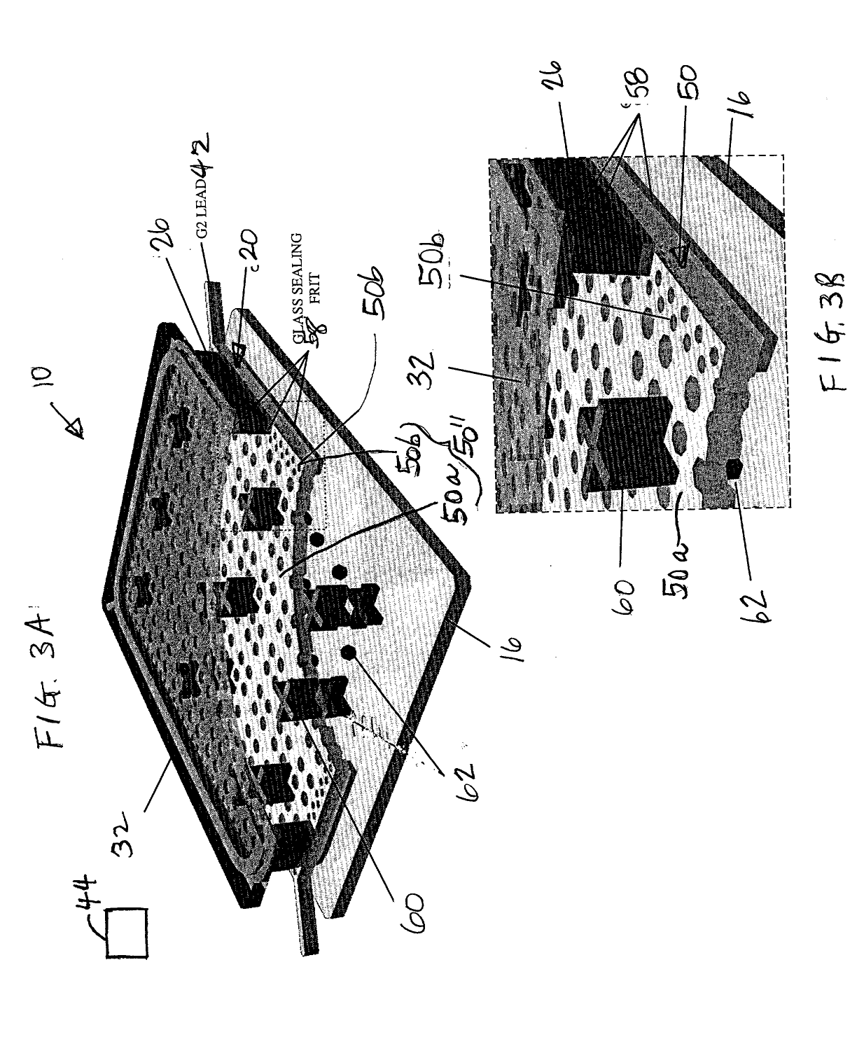

FIG. 3A is a perspective view of a portion of a flat panel display device 150 with a portion cut away to illustrate the third embodiment of the invention. FIG. 3B is an exploded view of a portion of the device in FIG. 3A. The embodiment of FIGS. 3A and 3B is taken from the companion application. Rim or sealing frame 26 may be attached to the micro-electron lens layer 50″ to form electrode structure 20, where the structure 20 is attached to the anode plate 12 by means of glass sealing frit 58. Anode spacer 60 may be attached to the layer 50″ and the anode 32 by means of glass sealing frit. For ease of assembly, these anode spacers may first be attached to layer 50″, so that the rim 26 and anode spacers 60 may be attached to the anode or anode plate in a single process. Cathode spacers 62 may also be formed on layer 50″. The perimeter portion 50b of layer 50″ and cathode spacers 62 may then be attached to the cathode plate 16 in a single process. When structure 20 is attached to the anode and cathode plates, the layer 50″ is properly aligned with the rows and/or columns of field emitter cathodes on the cathode plate 16 and with pixel dots on the anode. Once so aligned and the electrode structure 20 is attached to the cathode and anode plates, accurate alignment has been achieved.

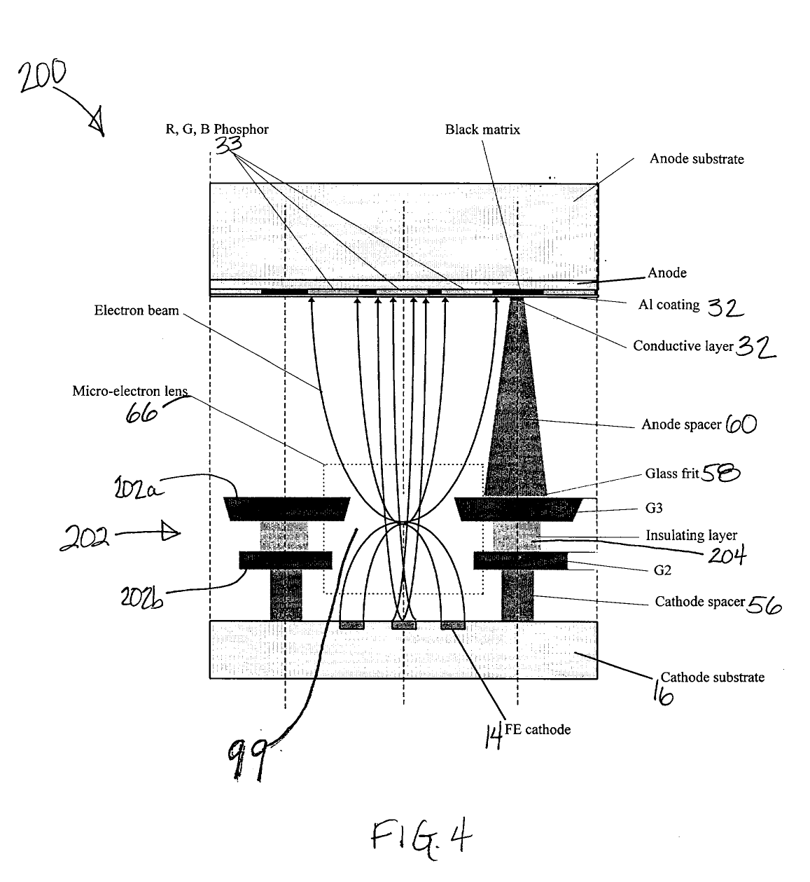

As noted above, the focusing and imaging characteristics of the micro-electron lens 50′ of FIG. 2 depend on the structural shape of the holes and the voltages applied to the anode, cathodes and micro-electron lens as well as distances between the anode, cathode elements and micro-electron lens, and the aperture shape of the micro-electron lens. For improved focusing, a composite micro-electron lens structure may be used. In the preferred embodiment, it may be desirable to employ multiple layers of conductive materials instead of a single layer of conductive material 50′ as in FIG. 2 to form a composite micro-electron lens. Such new configuration is shown in FIG. 4. Thus, as shown in FIG. 4, display device 200 is substantially similar to display 100 of FIG. 2, except that a multi-layer electrode structure 202 is employed instead of a single layer 50′ as in FIG. 2. As shown in FIG. 4, lens 202 includes two layers 202a, 202b, each made of an electrically conductive material, where the two layers are separated by an insulating layer 204. By employing two or more electrically conductive layers, it is possible to more accurately fabricate the apertures or holes therein so that their sizes and shapes are of the desired accuracy. Furthermore, different electrical potentials may be applied to layers 202a, 202b, further increasing the versatility and the control of the focusing and imaging functions of the micro-electron lens structure 202. By such focusing and/or imaging functions, the electrons emitted by the field emitter cathode elements in a small area on the cathode substrate or plate may be focused and imaged onto a larger area of the phosphor layer. Thus the addressing capability of the micro-electron lens can be realized by the composite structure of FIG. 4 in which additional control electrodes are formed onto the basic single layer micro-electron lens structure. The control electrodes combined with the specific basic functions of the single layer micro-electron lens structure are used for focusing and imaging, focusing and addressing as well as focusing, imaging and addressing.

The spacing between layers 202a, 202b is at least about 1 micron, while in the preferred embodiment, the spacing is at about 20 microns. For some applications, the holes or apertures in layer 202a are preferably smaller than those in layer 202b; for other applications, they may be of substantially the same size and shape. The lateral dimensions (i.e. the dimensions in a plane substantially parallel to the anode and cathode elements) of at least one of the holes are preferably at least one-tenth of the lateral extent (i.e. the dimensions of the two-dimensional area that the set of cathode elements occupies in a plane substantially parallel to the anode and cathode elements) of a corresponding set of cathode elements. In other words, the dimensions of holes 98, 99 in FIGS. 2, 4 are preferably at least one-tenth of the lateral extent of a corresponding set of cathode elements (e.g. set 14b) on the substrate 16. More preferably the dimensions of at least one of the holes are at least one-third of the lateral extent of a corresponding set of cathode elements. In other words, if the lateral extent of the corresponding set of cathode elements along a first direction (e.g. X) parallel to the surface of the cathode substrate 16 is x, then the dimension of the hole along such direction is preferably at least one-tenth of x and more preferably one-third of x. If the lateral extent of the corresponding set of cathode elements along a second direction orthogonal to the first direction (e.g. Y) parallel to the surface of the cathode substrate 16 is y, then the dimension of the hole along such direction is preferably at least one-tenth of y and more preferably one-third of y.

As in the embodiments described above, the height of the anode spacers 60 may be such that the spacing between layer 202a and the anode layer is spaced apart by at least about 0.5 millimeters, and preferably by at least about one millimeter. Preferably, the spacing between layer 202b and the cathode elements is at least about 20 microns. In the preferred embodiments, the spacing between layer 202b and the cathodes is within the range of 30 to 250 microns.

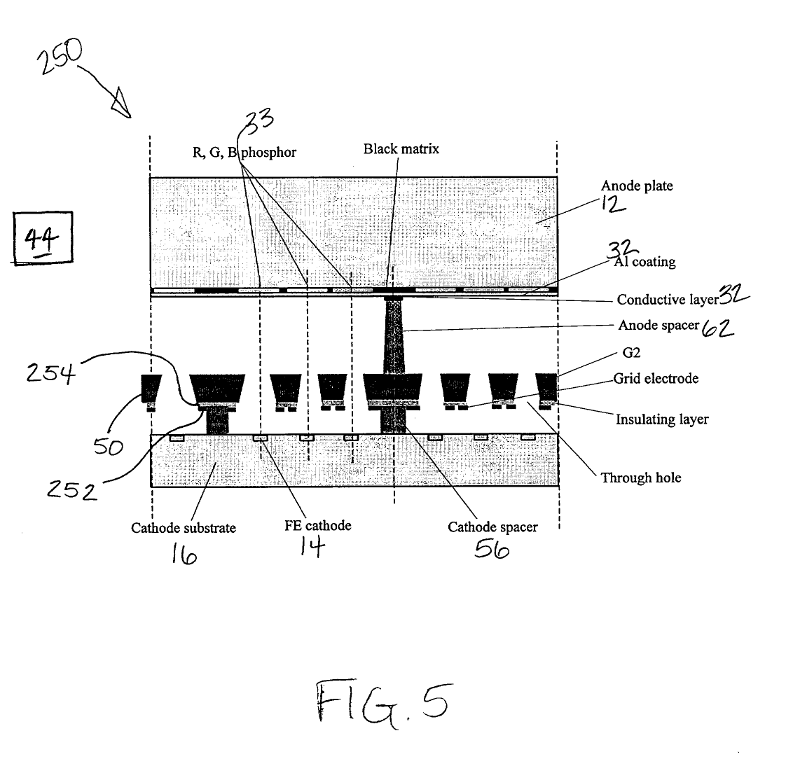

FIG. 5 is a cross-sectional view of display 250 which is substantially similar to display 10 of FIG. 1, except that device 250 includes an additional layer of grid electrodes which may be useful for controlling the addressing or brightness data control of device 250. Thus, power supply and controller 44 may apply scanning or data electrical potentials to the grid electrodes 252. This, together with the data or scanning electrical potentials applied to the rows or columns of sets of field emitter cathode elements, are adequate to control the addressing and brightness data control for displaying video images. Layer 252 is separated from layer 50 by means of an insulating layer 254. A similar layer of grid electrodes may also be formed on layer 50′ of FIG. 2 and on layer 202b of FIG. 4. Such and other variations are within the scope of the invention.

The above-described displays are particularly easy to manufacture compared to prior art displays such as that proposed by Nonomura et al. described above. The micro-electron lens may be formed simply by a layer of metal, such as layers 50 and 50′ of FIGS. 1 and 2. Even if the micro-electron lens structure includes multiple layers, such multi-layer structure is also simple to manufacture. Fabrication of the anode and cathode spacers and the alignment of the micro-electron lens structure with the pixel dots and sets of cathode elements can also be accomplished in a single process and in a simple manner.

While the invention has been described by reference to various embodiments, it will be understood that different changes and modifications may be made without departing from the scope of the invention which is to be defined only by the appended claims.

What is claimed is:

1. A flat panel display device for displaying images when viewed in a viewing direction, comprising:
a front face plate;
an anode on or near the front face plate;
a first layer of luminescent material on or near the anode, said layer comprising an array of rows and columns of sets of pixel dots of luminescent material, each set containing at least one pixel dot, each dot emitting red, blue or green light in response to electrons;
a cathode substrate;
an array of field emitter cathode elements on said cathode substrate, said array having rows and columns of sets of said elements, each set of elements containing at least one of said elements;
a structure including at least one second layer of electrically conductive material between the anode and cathodes, said at least one second layer defining a two dimensional array of holes therein, wherein each set of elements substantially overlaps an image of a set of corresponding pixel dots in the first layer through a corresponding hole in the second layer; and
means for supplying an electrical potential to the anode, a scanning electrical potential sequentially to rows or columns of said elements, data electrical potentials to columns or rows of the elements, and a focusing and/or imaging electrical potential to the at least one second layer, to cause electrons from each set of the cathode elements to reach said image of the set of corresponding pixel dots of the first layer for displaying desired images.

2. The device of claim 1, further comprising anode spacers between the at least one second layer and the face plate, said anode spacers having heights of not less than 0.5 millimeter.

3. The device of claim 1, wherein said applying means applies a voltage in the range of about 1000 to 10,000 volts to the anode.

4. The device of claim 1, wherein lateral dimensions of at least one of the holes are at least one-tenth of the lateral extent of a set of corresponding pixel dots in the first layer.

5. The device of claim 4, wherein lateral dimensions of at least one of the holes are at least one-third of the lateral extent of a set of corresponding cathode elements.

6. The device of claim 1, said structure comprising a plurality of layers of electrically conductive material between the anode and cathodes, each of said electrically conductive layers defining a two dimensional array of holes therein, wherein each hole in one of the electrically conductive layers substantially overlaps corresponding holes in the other electrically conductive layers when viewed in the viewing direction.

7. The device of claim 6, wherein for at least two of said electrically conductive layers, size of the holes in one of such layers is larger than or substantially equal to that of corresponding holes in the other of such layers, said applying means applying different voltages to the at least two of said electrically conductive layers.

8. The device of claim 6, wherein for at least two of said electrically conductive layers, the spacing between such two layers is at least about 20 microns.

9. The device of claim 1, wherein the at least one second layer is spaced at a distance of at least about 20 microns from the elements.

10. The device of claim 1, wherein the at least one second layer is spaced at a distance of at least about 0.5 millimeters from the anode.

11. A flat panel display device for displaying images when viewed in a viewing direction, comprising:
a front face plate;
an anode on or near the front face plate;
a first layer of luminescent material on or near the anode, said layer comprising an array of rows and columns of sets of pixel dots of luminescent material, each set containing at least one pixel dot, each dot emitting red, blue or green light in response to electrons;
a cathode substrate;
an array of field emitter cathode elements on said cathode substrate, said array having rows and columns of sets of said elements, each set of elements containing at least one of said elements;
a structure including at least one second layer of electrically conductive material between the anode and cathodes, said at least one second layer defining a two dimensional array of holes therein, wherein each set of elements substantially overlaps an image of a set of corresponding pixel dots in the first layer through a corresponding hole in the at least one second layer;
an array of grid electrodes between the anode and the elements; and
means for supplying a focusing and/or imaging electrical potential to the at least one second layer and electrical potentials to the anode, the sets of elements and the array of grid electrodes to cause electrons emitted by each set of the cathode elements to reach said image of the set of corresponding pixel dots of the first layer for displaying desired images.

12. The device of claim 11, further comprising anode spacers between the at least one second layer and the face plate, said anode spacers having heights of not less than 0.5 millimeter.

13. The device of claim 11, wherein said applying means applies a voltage in the range of about 1000 to 10,000 volts to the anode.

14. The device of claim 11, wherein lateral dimensions of at least one of the holes are at least one-tenth of the lateral extent of a set of corresponding cathode elements.

15. The device of claim 14, wherein lateral dimensions of at least one of the holes are at least one-third of the lateral extent of a set of corresponding cathode elements.

16. The device of claim 11, said structure comprising a plurality of layers of electrically conductive material between the anode and cathodes, each of said electrically conductive layers defining a two dimensional array of holes therein, wherein each hole in one of the electrically conductive layers substantially overlaps corresponding holes in the other electrically conductive layers when viewed in the viewing direction.

17. The device of claim 16, wherein for at least two of said electrically conductive layers, size of the holes in one of such layers is larger than or substantially equal to that of corresponding holes in the other of such layers, said applying means applying different voltages to the at least two of said electrically conductive layers.

18. The device of claim 16, wherein for at least two of said electrically conductive layers, the spacing between such two layers is at least about 20 microns.

19. The device of claim 11, wherein the array of grid electrodes is between the cathode elements and the at least one second layer.

20. The device of claim 11, wherein the array of grid electrodes is spaced at a distance of at least about 20 microns from the at least one second layer.

21. The device of claim 11, wherein the at least one second layer is spaced at a distance of at least about 20 microns from the elements.

22. The device of claim 11, wherein the at least one second layer is spaced at a distance of at least about 0.5 millimeters from the anode.
